(19) United States
(12) Patent Application Publication
(10) Pub. No.: US 2002/0110200 A1
(43) Pub. Date: Aug. 15, 2002

(54) Method for quadrature phase decoding allowing for skipped states

(75) Inventor: Philip W. Doberenz, Tigard, OR (US)

Correspondence Address: MARGER JOHNSON & MCCOLLOM PC, 1030 SW MORRISON STREET, PORTLAND, OR, 97205, US

(73) Assignee: Intel Corporation, Santa Clara, CA (US)

(21) Appl. No.: 09/741,220

(22) Filed: Dec. 19, 2000

(51) Int. Cl. H04L 27/14; H04L 27/16; H04L 27/22

(52) U.S. Cl. 375/324

(57) ABSTRACT

A method for decoding a pair of quadrature signals. The method includes obtaining three different samples of the quadrature outputs at three different times. A last sample direction is then determined from the first two samples. The last sample direction, and the second and third samples are then used to determine an output that may identify a skipped state, if a skipped state occurred. The last sample direction may be determined previous to obtaining the third sample, or it may be determined on the fly. A user pointing device in accordance with the invention is also discussed.

### BACKGROUND

1. Field

This invention relates to decoding methods for quadrature signal devices, more quadrature phase decoding methods.

2. Background

Quadrature phase decoding may be used to detect movement of an object. In a typical configuration, a decoder wheel is used, inset such that there are slots around the wheel. A phototransistor with two outputs A and B is positioned such that the A and B photosensors are aligned with the slots and offset ninety degrees. This results in the A and B outputs, typically square waves, being ninety degrees out of phase with each other. The two digital outputs then create four possible outputs, hence the name quadrature. An example of two, ninety degree out of phase, square waves is shown in FIG. 1.

In most motion detection applications of quadrature decoding, there are two decoder wheels and two sets of photosensors and phototransistors. Each set tracks on axis, having outputs XA, XB, YA and YB. Each set of outputs may be used in a state machine to determine an output signal. The output signals from both sets are compared to the previous state and then used to determine motion and direction. An example of a typical state machine used for one set is shown in FIG. 2. A lookup table for this state diagram is shown below.

| Present State | Last State | Output | Present State | Last State | Output |
|---|---|---|---|---|---|
| 00 | 00 | 0 | 10 | 00 | −1 |
| 00 | 01 | −1 | 10 | 01 | 0 |
| 00 | 10 | 1 | 10 | 10 | 0 |
| 00 | 11 | 0 | 10 | 11 | 1 |
| 01 | 00 | 1 | 11 | 00 | 0 |
| 01 | 01 | 0 | 11 | 01 | 1 |
| 01 | 10 | 0 | 11 | 10 | −1 |
| 01 | 11 | −1 | 11 | 11 | 0 |

With this method, every state must be sampled. If a state is skipped, the last state and present state information will not allow direction to be determined. If the object moves quickly, the quadrature frequency will increase. The quadrature frequency is the frequency at which the states change. Therefore, the sampling frequency must be set high enough to allow for fast movements. If the sampling rate is not high enough, a state will be skipped and the movement information will be lost, resulting in inaccurate tracking.

A common use for this type of movement detection and decoding is in user pointing devices, such as a computer mouse. The computer mouse may be connected to the host computer by a wire or by some sort of wireless connection, such as infrared. The output of the mouse to the host computer depends upon the results of the state changes and the corresponding outputs. This information allows the computer to depict the mouse movement on the screen with the cursor. If the data is inaccurate because of skipped states, the mouse will not be very useful. Similarly, having a high sampling rate for the mouse ties up computer resources. A more effective method for quadrature decoding may result in a lower sampling rate without loss of movement data.

### BRIEF DESCRIPTION OF THE DRAWINGS

The invention may be best understood by reading the disclosure with reference to the drawings, wherein:

FIG. 1 shows a prior art example of a quadrature phase diagram.

FIG. 2 shows an example of a prior art quadrature state diagram.

FIGS. 3a and 3b show examples of positive and negative state diagrams, respectively, in accordance with the invention.

FIG. 4 shows a flowchart of one embodiment of a method to decode quadrature signals in accordance with the invention.

FIG. 5 shows one embodiment of a user pointing device in accordance with the invention.

### DETAILED DESCRIPTION OF THE EMBODIMENTS

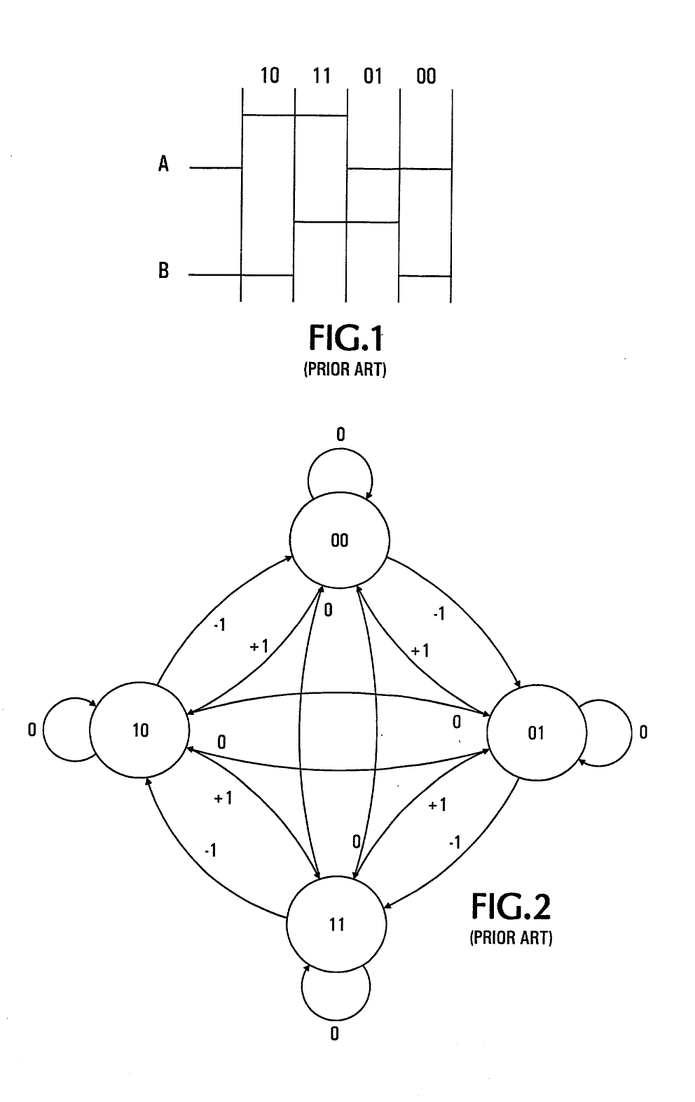

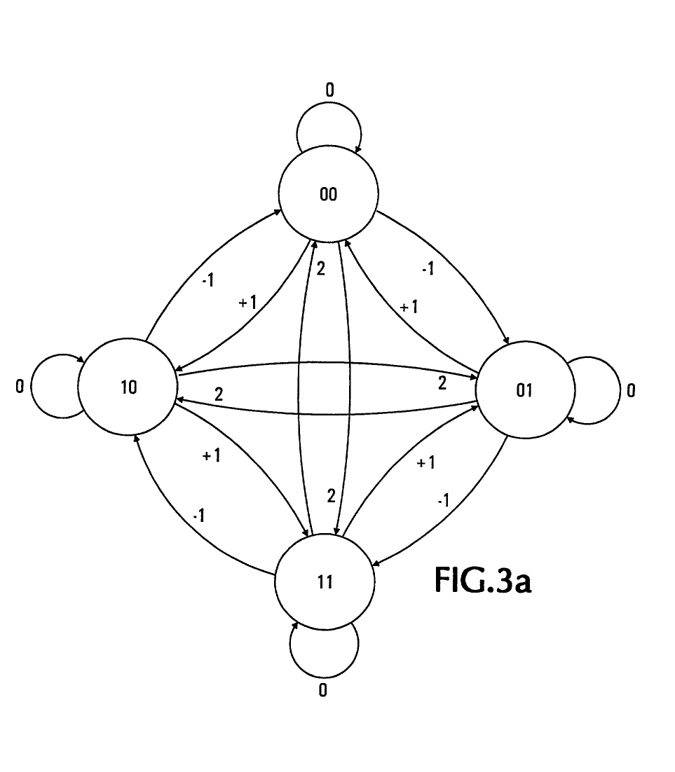

As mentioned previously, FIG. 1 shows a phase diagram for two outputs of a quadrature decoder pair. The output signals A and B are ninety degrees out of phase. This allows the system to detect the movement of a decoder wheel, and the corresponding movement of an object. A corresponding state diagram for these two signals is shown in FIG. 2.

In operation, the state machine may provide a way to track the movement of an object. For example, the object starts in a resting position, at state 00. As it moves, the square waves of the outputs A and B change as the decoder wheel spins. The movement may be from state 00 to state 10 to state 11, for example. If this state machine is for the X axis, the output for the X axis would be a 1 for the state change from 00 to 10 and another 1 for the state change 10 to 11. Typically, the current processes use the last state and the present state to determine direction of the move.

To determine movement and direction, these results are typically summed up and sent to the host computer. For example, assume that samples are taken every 200 microseconds, and an output is transmitted to the host computer every 10 milliseconds. In this example, 50 samples are taken during each period between transmissions. If the positive direction for the X axis state machine is to the right, and the positive direction for the Y axis state machine is up, a resulting output may be X+4, and Y+2. There may have been some direction reversals in between the two transmissions, but in general, the net movement was in a positive direction for both X and Y.

Each sample taken may or may not produce a new state. If the mouse is at rest between transmissions, there will be no state changes, and therefore there will be no outputs to sum. As the states change, for example, from 00 to 01 to 11, each would result in a 1, and the sum for that axis would be a net change of +2. In this manner, the state machine allows the controller or processor in the moving object to communicate movement to a host computer.

However, in the current state of the art a problem with regard to the sample rate occurs as the movement speed of the object increases. If the change from 00 to 10 to 11 accelerates, less time is spent in each state. The time spent in each state may become so short that the state is not sampled. This would result in the last state being 00 and the present state being 11. Since a state was skipped, the current implementations of state machines cannot tell if the object changed states by going in one direction, resulting in the sequence 00, 10, 11, or in the opposite direction, resulting in the sequence 00, 01, 11. Without last state data that is from a state sequential with the present state, the direction data is inaccurate or lost.

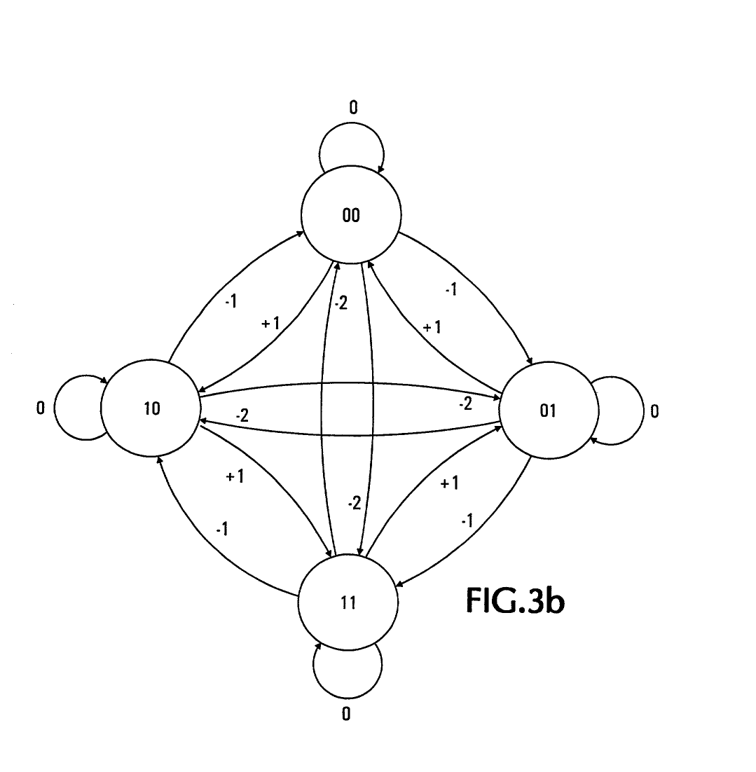

An embodiment of a set of state machines that can account for skipped states is shown in FIGS. 3a and 3b. As mentioned above, current implementations typically store the last state and the present state only. In this embodiment, both the last state and the direction of the last sample are used. The direction of the last sample may be determined by determining the direction between the last sample and the previous sample. A change in direction will typically not happen so quickly that a state will be skipped before a valid direction change can be determined.

In this embodiment the direction corresponding to changes from 00 to 10 to 11 to 01 to 00 will defined as the positive direction. The direction corresponding to changes from 00 to 01 to 10 to 00 will be defined as the negative direction. Using the direction of the last sample, referred to here as the last direction, the correct lookup table can be selected. If the last state, last direction and the present state indicate a skipped state, the table provides a different output. FIG. 3a shows one embodiment of a state diagram for the positive direction, for example. If a state is skipped, such as going from 00 to 11, the resulting output would be a+2, identifying a skipped state. This takes into account the change from 00 to 01, which should have resulted in a 1, and the change from 01 to 11, which should have resulted in another 1. The sum of the outputs of the two state changes is 2. The output tables are shown below.

Positive Direction

| Present State | Last State | Output | Present State | Last State | Output |
|---|---|---|---|---|---|
| 00 | 00 | 0 | 10 | 00 | −1 |
| 00 | 01 | −1 | 10 | 01 | 2 |
| 00 | 10 | 1 | 10 | 10 | 0 |
| 00 | 11 | 2 | 10 | 11 | 1 |
| 01 | 00 | 1 | 11 | 00 | 2 |
| 01 | 01 | 0 | 11 | 01 | 1 |
| 01 | 10 | 2 | 11 | 10 | −1 |
| 01 | 11 | −1 | 11 | 11 | 0 |

Negative Direction

| Present State | Last State | Output | Present State | Last State | Output |
|---|---|---|---|---|---|
| 00 | 00 | 0 | 10 | 00 | −1 |
| 00 | 01 | −1 | 10 | 01 | −2 |
| 00 | 10 | 1 | 10 | 10 | 0 |
| 00 | 11 | −2 | 10 | 11 | 1 |
| 01 | 00 | 1 | 11 | 00 | −2 |
| 01 | 01 | 0 | 11 | 01 | 1 |
| 01 | 10 | −2 | 11 | 10 | −1 |
| 01 | 11 | −1 | 11 | 11 | 0 |

Using these tables it is possible to identify a result where a state was skipped. When used in combination with the direction, it is possible to determine which state was skipped. Allowance of skipped states relaxes the sampling requirement. Lower sampling rates can be used for the same current object movement speed.

In the example of a user pointing device, such as a mouse, a lower sampling rate could be used for the same current mouse speed. Alternatively, the same sampling rate could be used and the maximum possible mouse speed could be increased, or a mix of the two. The mouse could have a faster speed without a jerky cursor movement, as would be the case using current approaches. Other devices that may use quadrature decoding include measuring devices, such as digital calipers.

The improved capability, whether it impact sampling rates or object speeds, may be provided to users in the form of software. A computer readable medium, such as a diskette, CD-ROM, or digital signal processor (DSP) image file would contain software code. The software code, when executed, would result in use of a method to obtain samples of the decoder photosensor outputs and use those samples to determine the outputs based upon the present state, last state and last sample direction.

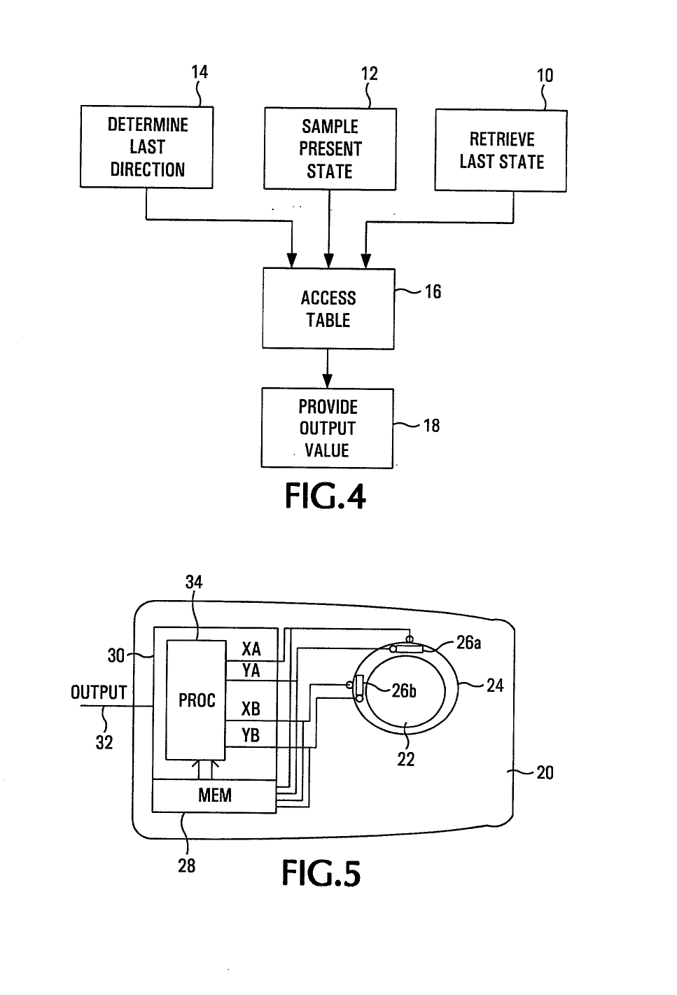

A flowchart of one embodiment of such a method is shown in FIG. 4. The last state is retrieved at 10 and the current sample is obtained at 12. These could be performed sequentially or in parallel, depending upon the desires of the designer. In addition, the direction of the last sample, referred to here as the last direction, is determined at 14. The last direction could be determined previously and stored.

For example, the current sample and the last sample will become the last sample and the previous when a new sample is obtained. The method could determine the direction between these two variables prior to obtaining the new sample. The variable stored would the last direction. When the new sample is obtained, the last sample and the last direction variables would be retrieved from wherever they are stored and used to determine the output of the state machine.

Alternatively, a first sample is taken. The value of the first sample will become the last state, and the sign of the sample will become the last direction. When a second sample is taken, the second sample is obtained, from which is determined the current state. These are used in determining the necessary output. In either case, as well as other embodiments, the last state and last direction will be determined in some manner using a first sample, and the current state will be determined using a second sample.

As discussed above, this approach can be used for tracking of objects using quadrature detection. One example given was that of a user pointing device, such as a mouse. In this example, the computer readable medium including the software code would more than likely be contained in a mouse driver file. One embodiment of a mouse capable of using such a driver in accordance with the invention is shown in FIG. 5.

The mouse 20 has a rolling ball 22. The rolling ball 22 is typically restrained from falling away from the mouse case by a ring 24. Underneath or otherwise adjacent the ring 24 are decoder wheels 26a and 26b. In this example, decoder wheel 26a is used for the X axis movement and decoder wheel 26b is used for the Y axis movement. Photosensors XA, XB, YA and YB provide input to the state machine 30, which is more than likely contained on a controller, processor or other integrated circuit. The state machine 30 and the memory 28 may be co-located on the same integrated circuit. The memory 28 may be any type of storage, including a memory register or a RAM array.

In one embodiment, the processor or controller stores the last state and direction, determined from the last sample. The state machine/controller 30 receives the inputs XA, XB, YA and YB as the current sample. It then accesses the memory to retrieve the last sample and the last direction. These inputs are then used to determine the appropriate output 32, which is sent to the host computer. Again, using the last sample direction, however determined, allows the sampling rate to be decreased, or the maximum speed of the object to be increased.

In this manner, a skipped state may be detected and adjusted for. This feature is also extensible to handling more than one skipped state. The velocity of the mouse, for example, relates to the frequency of the quadrature signals and may be very fast. The acceleration will actually be much slower. A person can only accelerate a hand so quickly. In addition, direction changes are also relatively slow. Even in these conditions, the skipped state quadrature decoder shown above overlaps enough to get accurate information when it is moving one state at a time in the direction that the other table is handling.

Since the acceleration is relatively slow, it is more like that when a state is skipped, the device is still moving in one direction. The decoding of skipped states can be extended to allow choosing of different tables if more states are skipped without inaccurate or lost data. This is shown by the table below.

| State Change | −3 | −2 | −1 | 0 | +1 | +2 | +3 |
|---|---|---|---|---|---|---|---|
| Standard Table | X | X | −1 | 0 | +1 | X | X |
| (prior art) | | | | | | | |
| A. Positive | | | −1 | 0 | +1 | +2 | |
| table | | | Table B | Keep | Keep | Table C | |
| 1 skipped state | | | | | | | |
| B. Negative | | −2 | −1 | 0 | +1 | | |
| table | | Table D | Keep | Keep | Table A | | |
| 1 skipped state | | | | | | | |
| C. Positive | | | | 0 | +1 | +2 | +3 |
| table | | | | Table A | Keep | Keep | |
| 2 skipped states | | | | | | | |
| D. Negative | −3 | −2 | −1 | 0 | | | |
| table | | Keep | Keep | Table B | | | |
| 2 skipped states | | | | | | | |

Indications of “Table B,” for example, indicate that the output should be acquired from the values of Table B. The indicator “Keep” direct the output to be obtained from the current table.

Thus, although there has been described to this point a particular embodiment for a method and apparatus for improved quadrature detection and decoding, it is not intended that such specific references be considered as limitations upon the scope of this invention except in-so-far as set forth in the following claims.

What is claimed is:

1. A method for decoding a pair of quadrature signals, the method comprising:
a) obtaining a first sample;
b) determining a last direction and a last state using the first sample;
c) obtaining a second sample, wherein a current state is determined using the second sample;
d) generating an output responsive to the last sample, a last direction and their current state.

2. The method of claim 1, wherein the method is performed for an X axis pair and a Y axis pair.

3. The method of claim 1, wherein generating an output further comprises looking up the output in a positive look-up table if the direction is positive; and looking up the output in a negative look-up table if the direction is negative.

4. The method of claim 1, wherein the quadrature signals are generated by a user input device.

5. The method of claim 1, wherein the method further comprises determining motion and rotation direction from the output.

6. The method of claim 3, wherein there are more than one positive look-up tables and more than one negative look-up tables and the selection of a look-up table depends upon a number of states that were skipped.

7. The method of claim 1, wherein the method further comprises summing outputs generated during a predetermined period, and transmitting a sum for each axis of movement at the end of the period.

8. A method for decoding a pair of quadrature signals, the method comprising:
a) obtaining a first sample of the quadrature signals at a first time;
b) determining a last direction and a last state from the first sample;
c) obtaining a second sample of the quadrature signals at a second time; and
d) determining an output signal using the last state, the last direction and the current state.

9. The method of claim 8, wherein the method further comprises summing output signals for a predetermined length of time.

10. The method of claim 9, wherein the method further comprises providing an output signal to a host computer comprised of a sum of outputs.

11. The method of claim 8, wherein the last direction is one of either positive or negative direction.

12. The method of claim 11, wherein different lookup tables are used depending upon the last direction being positive or negative.

13. A computer readable medium, having included thereon software code that when executed, results in:
a) capture of a first sample of the quadrature signals at a first time;
b) capture of a second sample of the quadrature signals at a second time;
c) determination of a last direction;
d) generation of an output responsive to the first sample, the second sample and the last direction.

14. The computer readable medium of claim 14, wherein the software code is contained in a downloadable file.

15. The computer readable medium of claim 13, wherein the software code, when executed further results in:
a) summation of outputs for a predetermined period of time, thereby creating a net change sum; and
b) transmitting the net change sum to a host computer.
